(19) United States
(12) Patent Application Publication
(10) Pub. No.: US 2007/0255732 A1
(43) Pub. Date: Nov. 1, 2007

(54) Method and Apparatus for Implementing a Semantic Environment Including Multi-Search Term Storage and Retrieval of Data and Content

(76) Inventor: Barrie Jon Moss, Cumbria (GB)

Correspondence Address: REED SMITH, LLP, TWO EMBARCADERO CENTER, SUITE 2000, SAN FRANCISCO, CA, 94111, US

(21) Appl. No.: 11/380,636

(22) Filed: Apr. 27, 2006

(51) Int. Cl. G06F 7/00

(52) U.S. Cl. 707/100

(57) ABSTRACT

A method for finding the data on whatever system it is stored. The method stores descriptions of each piece of data in a manner. Users, for example, use more that one term to describe the data. Data retrieval is then facilitated such that the user can find stored data by means of a search function utilizing the stored descriptions.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention relates to domains and storage/retrieval of data. In various embodiments, the invention is more particularly related to a distributed content set offering separate storage and organizational domains connected by a procurement service.

2. Discussion of Background

As the Digital Revolution advances, more and more content is being virtualized and made available on digital devices. Unfortunately the software control systems (such as but not limited to operating systems) provide limited “single presence” organizational solutions in which the individual pieces of content are exclusively embedded into a highly structured domain (such as but not limited to a traditional file system).

Currently, for example, all file systems (Windows, UNIX/Linux, Mac) use a file system to store data in a hierarchal manner with a filename as a means to describe it. This makes searching for any particular piece of data a slow process as there is no means to use more than one term to describe the data.

This severely limits the ability of humans to develop, understand, query and manipulate the growing content set, leading to raised levels of usage friction.

### SUMMARY OF THE INVENTION

The present inventors have realized the need for better search and retrieval of documents stored on individual systems and/or across multiple systems (e.g., any of computers or storage devices individually or on networks, multiple networks and devices attached thereto, etc).

Roughly described, the present invention is an intelligent file system that makes the storing of file descriptions part of an aggregation of metadata about the file contents in a separate structure optimized for search and query. The separate structure provides a rich source on which query processes can operate. The query of the separate structure makes it easier to locate those files since there is more information and can be used to aid in the process of locating files across devices. It makes the searching and retrieving of files much easier.

The present invention provides, for example, a method for finding data on whatever system it is stored. Descriptions of each piece of data are stored in a manner where users can use more than one term to describe that data and the user can find the data by means of a much faster search function than what is currently available.

The present invention may be embodied in a method, comprising the steps of, identifying an entity comprising a resource, assigning a token to the entity, associating at least one meaning to tokens, and placing the token in at least one organizational structure. The organizational structure is, for example, a catalog that can be search using a vocabulary. The step of associating comprises creating an explicit association.

The present invention may also be embodied in a device, comprising, means for establishing token representations of assets on a device, means for cataloging the token representations, means for associating descriptive identifiers of the tokenized assets with the cataloged token representations, and vocabulary means for identifying a desired one of the tokenized cataloged assets. The assets comprise, for example, computer readable datafiles corresponding to any of photographs, music, and videos, or computer executable program files corresponding to any of games, entertainment packs, and/or players for any of photographs, music, and videos.

The present invention may be embodied in a platform independent operating system capable of running on portable devices. The present invention also includes communications for transmitting vocabulary based searches across a network to a central catalog device for identifying an asset or assets matching the vocabulary based searches on other devices located or accessible via the network.

Portions of both the device and method may be conveniently implemented in programming on a data storage device such as a SIM card, that is operable in any of a general purpose computer, networked computers, or any of portable/handheld devices, and the results may be displayed on an output device connected to any of the general purpose, networked computers, handheld/portable devices, or transmitted to a remote device for output or display. In addition, any components of the present invention represented in a computer program, data sequences, and/or control signals may be embodied as an electronic signal broadcast (or transmitted) at any frequency in any medium including, but not limited to, wireless broadcasts, and transmissions over copper wire(s), fiber optic cable(s), and co-ax cable(s), etc.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a drawing illustrating relationships between descriptors and associated Vocabulary, Catalog, virtualized token and entity sets according to an embodiment of the present invention;

FIG. 2 is a flow chart illustrating a process for building a portion of a semantic environment according to an embodiment of the present invention;

FIG. 3 is a drawing illustrating a view of vocabulary, catalog, and virtualized and entity sets according to an embodiment of the present invention;

FIG. 4 is a block diagram illustrating relationships of public and restricted catalogs between a set of users according to an embodiment of the present invention;

FIG. 5 is a block diagram illustrating relationships of public and restricted vocabularies between a set of users according to an embodiment of the present invention;

FIG. 6 is a flow chart of a process for add/delete/modify operations on a vocabulary according to an embodiment of the present invention;

FIG. 7 is a flow chart of a process for entity adding/deleting according to an embodiment of the present invention;

FIG. 8 is a flow chart of a process for adding/modifying/deleting descriptors according to an embodiment of the present invention;

FIG. 9 is a flow chart of a query operation according to an embodiment of the present invention;

FIG. 10 is an example of a local entity set on a user device according to an embodiment of the present invention; and

FIG. 11 is an illustration of a distributed entity set according to an embodiment of the present invention.

### DESCRIPTION OF THE PREFERRED EMBODIMENTS

As noted above, the present invention includes a method for finding data on whatever system it is stored. Descriptions of each piece of data are stored in a manner where users can use more than one term to describe that data and the user can find the data by means of a much faster search function than what is currently available.

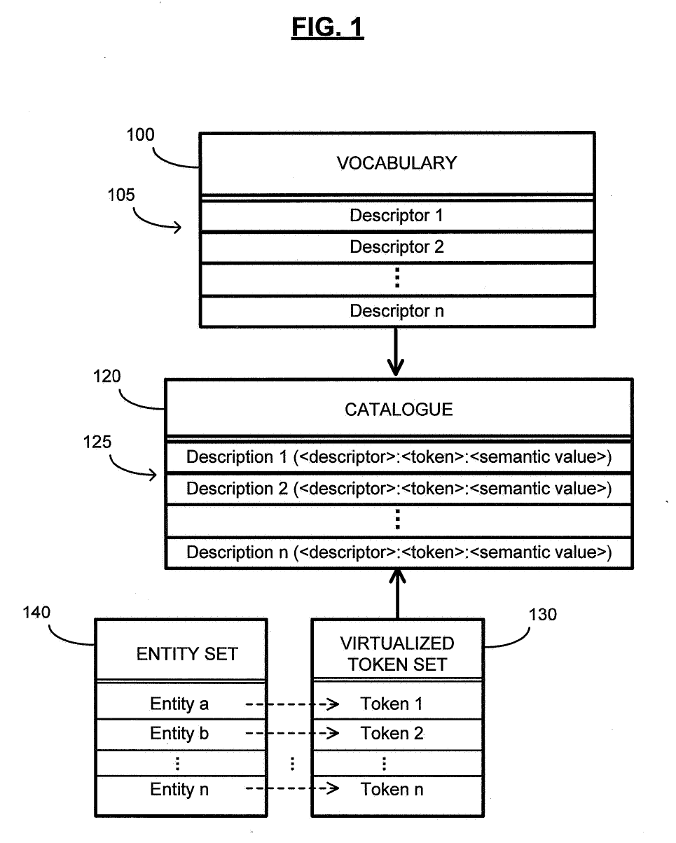

Referring now to the drawings, wherein like reference numerals designate identical or corresponding parts, and more particularly to FIG. 1 thereof, there is illustrated a drawing illustrating relationships between descriptors and associated vocabulary 100, Catalog 120, virtualized token and entity sets (130 and 140 respectively) according to an embodiment of the present invention. An entity set is a set of one or more entities, and a virtualized token set is a set of one or more tokens.

The entity set 140 is shown having n members (a . . . n). Each entity set member is associated with a token in the virtualized token set 130. The virtualized tokens are used to populate a Catalog 120, including descriptions (e.g., descriptions 125). The Catalog is then available and interacts with vocabulary 100 in conjunction with descriptors 105. The vocabulary is a logically associated, uniquely named set of one or more of the uniquely named descriptors 105.

In other words, as a catalog is a set of 1 or more descriptions so a vocabulary is a set of 1 or more descriptors. Operating within the constructs of the vocabulary, the catalog 120 is searched to identify the token associated with the entity that is desired to be found or operated on. The search yields the token which is then communicated, stored, or used to manipulate the underlying entity.

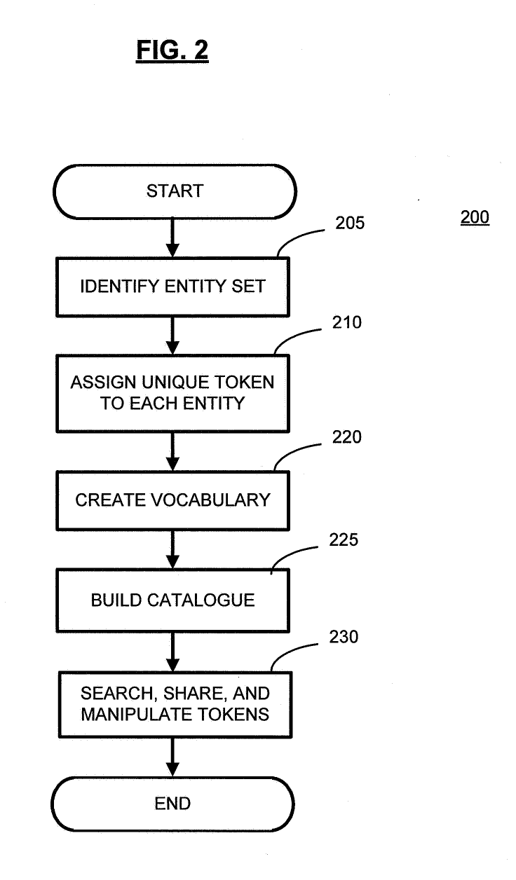

In more detail, the invention is a “semantic” or “meaning based” referential and organizational solution for a member entity set. FIG. 2 is flow chart of a process 200 for preparing a semantic organizational solution according to an embodiment of the present invention. An “entity set” consists of a set of unique objects and/or operations (e.g., entity set 140). These objects and operations can be physical or virtual. This is illustrated, for example, at Step 205, Identify entity set.

Each “entity” member within the entity set is given a unique identification token (a number, for example). This token provides a one to one abstracted representation of the entity within the “virtualized token set”. Step 210: assign and associate token to entity.

For example, Table 1 illustrates an entity set and associated tokens:

TABLE 1

| Entity | Token |
|---|---|
| Picture_of_mum.png | 1 |
| JailhouseRock.mp3 | 2 |
| Quake.exe | 3 |
| PatentApp.rtf | 4 |

In this example, the entity set 140 would be “Picture_of_mum.png”, “JailhouseRock.mp3”, “Quake.exe”, and “PatentApp.rtf.” The virtualized token set would be 1, 2, 3, and 4 respectively.

The purpose of the tokenization is that a customer (such as but not limited to a digital device user) desiring to access or otherwise manipulate the entities does not do so directly, but instead, does so indirectly via the associated token.

The present invention includes virtualized token sets of two types:

1) Bound, where each token is associated with a physical entity, such as a png or mp3 file that can be procured; and

2) Abstract, where each token is the entity itself because no binding can take place, for example a non player character in a game.

This tokenized abstraction creates a two part system allowing for the separation of entity storage from organization. The two parts are connected via a procurement service. The point of the abstraction is that the end user will deal with the tokens (e.g., search, manipulate, etc.) and not the actual entities themselves. This protects them and allows for meta/semantic data to be generated independent of the entities via referential association.

A customer can manipulate, organize and query the virtualized token set without needing to access or consider the entity set. Similarly entity storage services can distribute and store their entity set without having to access or consider the token set.

As an example, consider that a customer has taken 36 pictures on a digital camera and loaded them into the virtual domain. They then clear the camera, take 24 more pictures and load them into the virtual domain. They may chose to create one virtualized token set:

[1-60]

where both sets of photos are referenced in a single virtualized token set. On the other hand, it may be chosen to keep them separated, creating one for each download session.

[1-36]
[1-24]

Each token can have meaning attached to it. A customer in the organizational domain is able to apply meaning implicitly and explicitly. For example, a customer could create a set structure and name the set “My Games”. They could then place the token 3 into the set. Token 3 is now implicitly considered to be “a game”. Step 220, Attach/associate meanings to tokens—e.g., create set structure.

It should be pointed out here that all meaning is associative. In other words, if a customer puts a picture entity token into a set called “My Music” then by association this is considered to be “music”. Whether the token (and thus the entity) actually exhibits the property associated with it is the responsibility of the associator. Further, semantic domains are naturally localizable, such that they can be used with other languages and can have the same catalog mapped to different languages if required.

As each token is an abstraction, it can appear in more than one organizational structure. This allows for a token to be a member of more than one structure and thus have multiple pieces of semantic data assigned to it. This leads to the creation of a rich semantic domain. Step 225, Place token in one or more organizational structures.

Explicit association is done by using a mechanism called a “vocabulary” (e.g., vocabulary 100). The vocabulary is a logically associated, uniquely named set of one or more uniquely named descriptors. Step 230 create vocabulary for explicit association.

Continuing with the above photo related example, a vocabulary might include, for example, the following:

[vocabulary

[photos

[person as string]
[place as string]
[date as date]
[time as time]

]

]

This is a vocabulary called “photos” which has 4 descriptors [person, place, date, time]. The descriptors provide semantic value associated with the token. Thus, a descriptor is an abstract entity which defines a 1:1 associative relationship between a token and a semantic value.

Examples of descriptors include:

[descriptor

[name as string]
[colour as static set

[red,blue,green]

]
[person as dynamic set string]
[size as number]

]

In one embodiment, each descriptor must have the following properties described for it:

(1) Name. Whilst a descriptor is internally defined via its abstracted sequence number within the vocabulary, it must also have a name unique within the vocabulary.

(2) Format. Some example base formats are:
string (probably called word if this is to be exposed to non developers) for storing linguistic data;
whole number;
decimal number;
date; and
time

(3) Set. A set is a modifier for the format and serves as a type of enumeration. A static set is a standard enumeration (e.g. see the descriptor ‘colour’ in the above definition). A dynamic set is something more complicated. It learns its various members via usage. In the above vocabulary for example, person is a good example of a dynamic set. Every time a value is offered for the person descriptor, it will be checked against the current descriptor value set. If it is not in that set then (the service) will ask if this is a valid value and if it should be added to the descriptor set. The purpose of dynamic sets is to remove redundancy—for example Mrs Jane Doe might also be called Sister, Mother, Gran, Granny Doe etc.

(4) Application. The amount of times a descriptor must have a value applied to a specific token. Examples include:
Zero or Once;
Zero, Once or More;
Once—in other words it is mandatory; and
Once or More—in other words at least one entry is mandatory.
   Step 230: retrieve descriptor properties is an illustration of descriptor property retrieval.

A “description” is an instance of this 1:1 relationship, is, for example, formally defined as:

[<token>:<semantic value>]

For example, for descriptor [place], token [4] and semantic value [Rome], a description could be:

[description

[place

[4:Rome]

]

]

This would be appropriate in our example if the picture associated with token [4] was a picture of, or taken in Rome.

A catalog is an instance of a vocabulary applied to a virtualized token set. Step 235: Build Catalog from instance of vocabulary. For example here we have the vocabulary [photos] applied against a virtualized token set of [1-60].

[catalog

[photos, [1-60]

[person

[5:Mum]
[5:Dad]
[23:Granny]
[29:Dad]

]
[place

[5:Rome]
[9:Naples]
[23:Rome]

]

]

]

From the above, it follows that a valid catalog can be sparsely populated. In other words only a few descriptions have been created. It also follows that some descriptions allow for multiple values per token whilst others can have multiple tokens per value. The rules governing this are defined in the vocabulary and can also be overridden in the catalog if desired (as long as the integrity of the vocabulary is not broken).

For a catalog, a “descriptor description” set applies to a single descriptor that has at least one description and is the set of all descriptions for that specific descriptor. A catalog can be seen as the sum of all descriptor description sets for a specific vocabulary and token set. Using the example descriptor [person], its descriptor description set would be, for example:

[descriptor description set

[person

[5:Mum]
[5:Dad]
[23:Granny]
[29:Dad]

]

]

For a catalog, a “descriptor token set” is the set of all tokens within the corresponding descriptor description set. In our example, the descriptor token set for [person] would be, for example:

[descriptor token set

[person

[5,23,29]

]

]

As can be seen, the tokens are flattened (have all duplicates removed). For example, see Step 240, 245: Build token sets; Remove duplicates from token sets.

For a catalog, a “descriptor value set” is the set of all values within the corresponding descriptor description set. In our example, the descriptor instance value set for [person] would be, for example:

[descriptor value set

[person

[Mum,Dad,Granny]

]

]

As can be seen, the references are flattened (have all duplicates removed). For example, see Step 250, 255: Build descriptor value sets; Remove duplicates from descriptor value sets.

For a vocabulary, a “descriptor valid value set” is the set of valid values allowed for that descriptor. This can be used in two modes. In a static mode, the vocabulary designer can set the valid range of values whilst in a dynamic mode, the existing set of values is first used as comparison for the new value. If the value is not present then the customer is alerted to the fact and asked whether they want to add the value to the valid value set.

For a catalog, the “vocabulary used descriptor set” is the set of descriptors for a vocabulary that have at least one description in the catalog. In the example, this would be, for example:

[vocabulary used descriptor set

[person,place]

]

This is because both [person] and [place] have at least one description in the catalog whereas [time] has no description.

For a catalog, a “used token set” is the set of tokens that have been used in at least one description. In the example, this would be

[used token set

[5,9,23,29]

]

A customer is able to create their own vocabularies as well as use third party vocabularies. The catalogs created can be public (where any other user can see them) or private (where access to them is restricted), A customer is able to construct complex relationships using the semantic domain. These can be used both for organization and for query/retrieval. For example, see step 260: construct relationships using the semantic domain.

For example, a customer could define a relationship such as:

Picture: resource.type=“png”

Which would provide a simple set of all tokens that have been described using the resource vocabulary as a “png”.

Equally, this relationship could be extended as:

Picture: resource.type=[“png”, “jpeg”, “gif”, “bmp”]

Further, the defined relationships could be applied across multiple vocabularies:

Holiday in Rome: Picture and photo.place=“Rome”

A relationship is a dynamic entity in that as a customer adds descriptions to the semantic domain, new tokens may join or leave the relationship.

A query is similar to a relationship except that whereas a relationship is dynamically managed, a query is asked only once and returns a result set that is a snapshot of the semantic domain at the time that the query was executed.

Vocabularies are inherently localizable, since every entity within it (descriptor and semantic values) are themselves abstracted entities to which meaning is applied. For example:
Vocabulary [kitchen] descriptor [bread]
Vocabulary [cuisine] descriptor [pain]

Are themselves semantic associations for the same entities.

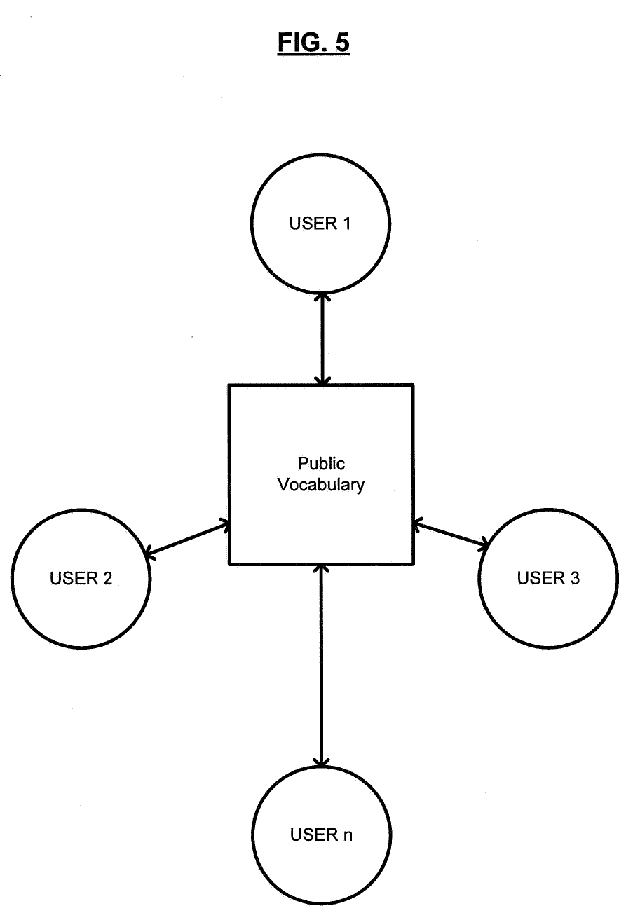

FIG. 2 only represents one possible way of implementing portions of the present invention. In one embodiment, vocabularies will already exist before entity sets/token sets are created. For example, consider a set of pictures on User X's computer, and a second set of pictures on User Y's computer. Both user X and user Y could utilize a pre-existing ‘picture’ vocabulary. Further, as conceptualized in FIG. 5 discussed further below, either of the users could create, use, and/or share their own vocabulary.

Each step illustrated in FIG. 2 may be broken down into smaller parts and then used in virtually any number of configurations. Several possibilities are described below in Tables (a)-(f) as pseudo code. The tables and pseudo code therein are not intended to represent executable or compilable sections of code, but instead are intended to illustrate the overall structure of programming that can implement portions of this embodiment of the present invention. Even these smaller parts only represent a limited number of possibilities for any single specific or set of implementations of the semantic domain.

TABLE (a)
Vocabulary Creation

| | |
|---|---|
| (10) | Define Name |
| (20) | Assign UUID (Universally Unique ID) |
| (30) | Define Descriptor Name |
| (40) | Define Descriptor Format |
| (50) | Define Descriptor Set |
| (60) | Define Application |
| (70) | If more descriptors, goto 30 |
| (80) | Build Vocabulary package for Distribution/Use |
| | in Catalogs |
| (90) | Stop |

TABLE (b)
Entity Set Creation

| | |
|---|---|
| (10) | Define Entity Set Name |
| (20) | Assign UUID |
| (30) | Enter entity procurement (could be a filename, |
| | a URL or some other means of accessing the entity) |
| (40) | Reject if already a member |
| (50) | Add as Set Member |
| (60) | If more entities, goto 30 |
| (70) | Stop |

TABLE (c)
Token Set Creation

| | |
|---|---|
| (10) | Define Token Set Name |
| (20) | Assign UUID |
| (30) | Select Entity Set to be used |
| (40) | Set Next Available Token value to 1 |
| (50) | If no members in the Entity Set, goto 110 |
| (60) | Read First Entity Set member |
| (70) | Store Token value: Entity Set member pair |
| (80) | Add 1 to Token value |
| (90) | Read Next Entity Set member |
| (100) | If Read found a member, goto 70 |
| (110) | Store Next Available Token value |
| (120) | Stop |

TABLE (d)
Catalog Creation

| | |
|---|---|
| (10) | Assign UUID |
| (20) | Select Token Set to be used |
| (30) | Select Vocabulary to be used |
| (40) | Stop |

TABLE (e)
Description Creation

| | |
|---|---|
| (10) | Select Catalog to be used |
| (20) | Select Token to be described from Token Set |
| (30) | Select Descriptor to be used |
| (40) | Enter Semantic value for description |
| (50) | Validate description |
| (60) | If invalid, goto 110 |
| (70) | Store description |
| (80) | Inform token set of description |
| (90) | If more descriptions, goto 20 |
| (100) | Stop |
| (110) | Error |
| (120) | Stop |

TABLE (f)
Query

| | |
|---|---|
| (10) | Enter Query |
| (20) | Validate Syntax |
| (30) | If invalid, goto 150 |
| (40) | Extract catalog set |
| (50) | Validate catalog set |
| (60) | If invalid, goto 150 |
| (70) | For each catalog |
| (80) | Validate descriptor set |
| (90) | If invalid, goto 150 |
| (100) | For each descriptor in each catalog |
| (110) | Build result set |
| (120) | Apply boolean conditions in Query to |
| | descriptor result sets to build final result set |
| (130) | Present final result set |
| (140) | Stop |
| (150) | Error |
| (160) | Stop |

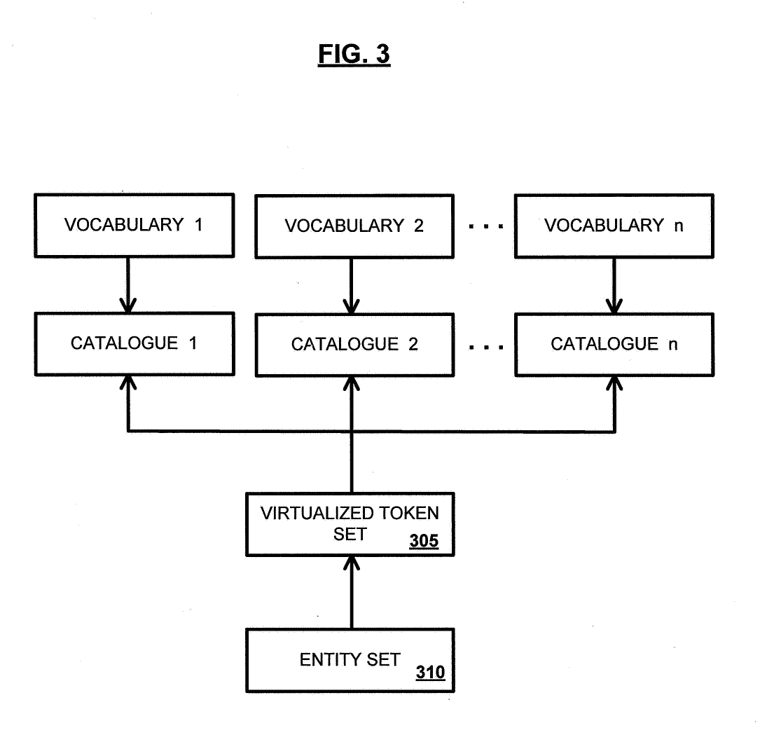

FIG. 3 is a drawing illustrating a view of vocabulary, catalog, and virtualized and entity sets according to an embodiment of the present invention. As shown in FIG. 3, a set of Vocabularies 1 . . . n are supported by each of corresponding catalogs 1 . . . n. Each catalog is derived fro the virtualized token set 305 which themselves are derived from the actual entity set 310.

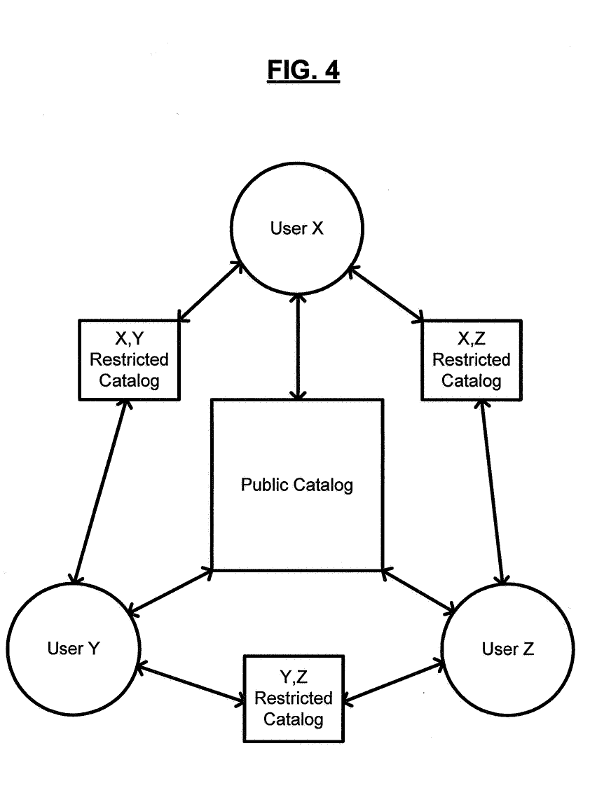

Catalogs can be private, restricted, or public. FIG. 4 and FIG. 5 are diagrams of vocabulary and catalog sharing according to embodiments of the present invention. FIG. 4 presents catalogs accessible by hypothetical users X, Y, and Z. Each of the users has access to public catalog 400. Within the constructs of a related vocabulary, each user can search to identify token in the public catalog 400.

FIG. 4 also illustrates restricted catalogs between each of the users (e.g., x-y restricted, x-z restricted, and z-y restricted catalogs). Each restricted catalog may be used by the users to whom the catalog is restricted to search and identify tokens.

Vocabularies can be private, restricted, or public. FIG. 5 presents a public vocabulary 500 that is available to all users. Operating within the constructs of the public vocabulary 500, the catalog(s) associated with it can be searched by any public user. As shown in FIG. 5, users 1,2,3, . . . n have public access and may search using the public vocabulary 500.

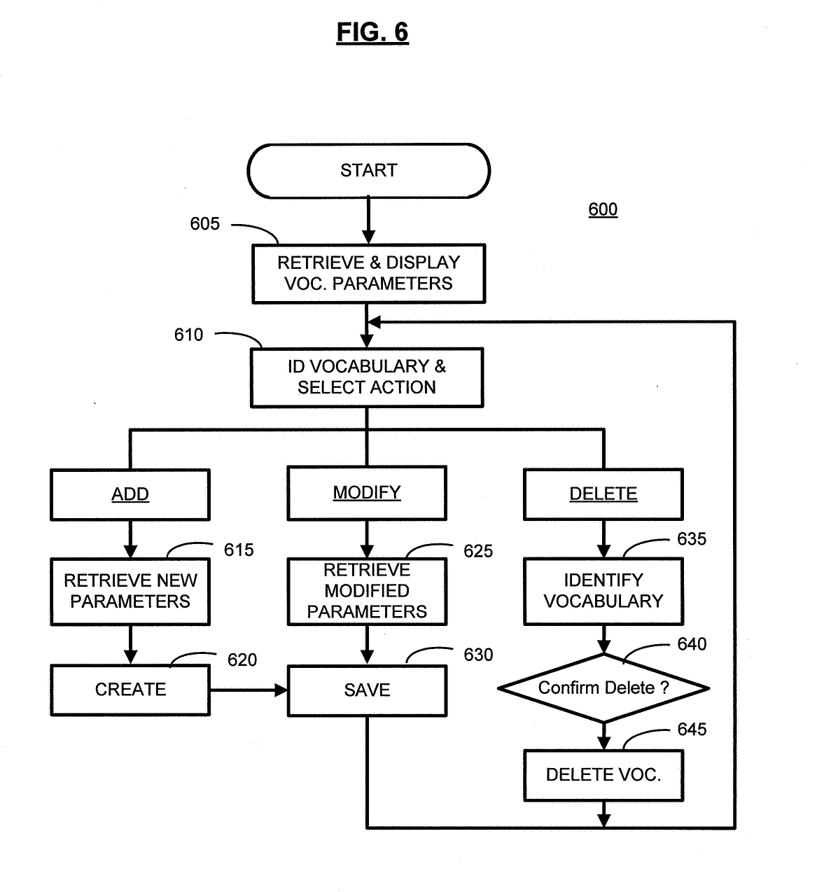

FIG. 6 is a flow chart of a process for add/delete/modify operations on a vocabulary according to an embodiment of the present invention. The operations allow a user change the properties of the user's vocabularies. These operations are significant because there can be multiple vocabulary sets—for example, you could have your set of private vocabularies, I could have mine and we could share some. Vocabularies can thus be owned and restricted or they can be open and public. The operations provide, for example, for a user that may want to change a public (or open) vocabulary to a restricted or private vocabulary. The process begins, for example, at step 605 by retrieving and displaying a list of current vocabularies and their parameters. The display is, for example, a web like Graphical User Interface, or a spreadsheet listing that identifies each vocabulary and it parameters. At step 610, the user identifies a vocabulary and selects an action (e.g., ADD, MODIFY, or DELETE). If ADD is selected, parameters of a new vocabulary are retrieved (Step 615). The new parameters may, for example, be cloned from an existing vocabulary or specifically selected by the user. At step 620, a new vocabulary is created based on the retrieved parameters.

If MODIFY was selected, modified parameters are retrieved (step 625). The modified parameters are, for example, provided by the user through selection of an existing parameter and value from a set of displayed parameters and values and changing the selected value to the new modified parameter value. Whether new or a modified value, it is saved in/in association with the vocabulary (step 630).

Finally, if DELETE was selected, the vocabulary id identified (step 635). A confirmation message (step 640) is displayed to confirm that the identified vocabulary is to be deleted, and, if affirmed, the identified vocabulary is deleted at step 645. In one embodiment, the entity is removed but the semantic data remains, leaving a ‘memory’ of that entity.

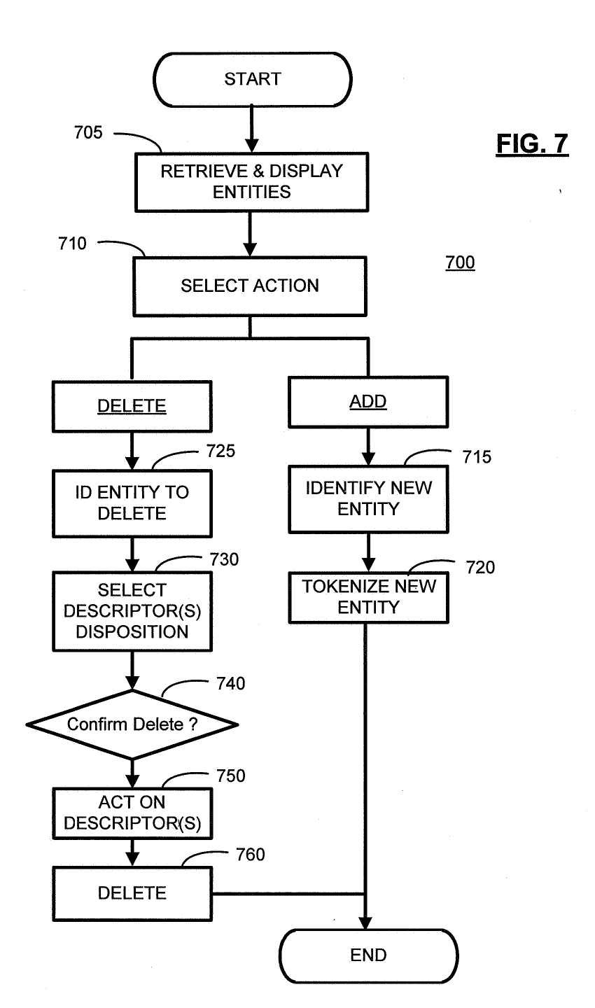

FIG. 7 is a flow chart of a process for entity adding/deleting according to an embodiment of the present invention. The process include, for example, that entities can be added, which means they are now available for describing. Equally an entity could be removed, which means we then have to decide what to do about any descriptions attached to the token (e.g., are the descriptions kept, or are they removed?).

The process begins, for example by retrieving and displaying a user's entities (step 705). At step 710, the user selects an action (e.g., DELETE or ADD). IF ADD is selected, a new entity is identified at step 715. The entity is identified, for example, by browsing through the user's files and selecting the file/entity to add. Entities may also include, for example, files, video, programs, or services. The identified entity is tokenized and associated with descriptors as described elsewhere herein.

If the user selects DELETE, an existing entity is identified (step 725), and the disposition of the descriptors is selected (step 730). The disposition of the descriptors is an identification of what to do with the descriptors. For example, are the descriptors deleted along with the entity, or are the descriptors saved (e.g., to be re-used with subsequently created or other existing entities). At step 740, deletion is confirmed, and then the descriptors are operated on in accordance with the selected disposition (step 750) and the entity is deleted (step 760).

The removal of an entity from the Entity Set can optionally be set to either remove the associated token from the token set, with the removal of all descriptions involving that token or the token can be left. In this case a semantic ‘memory’ is retained.

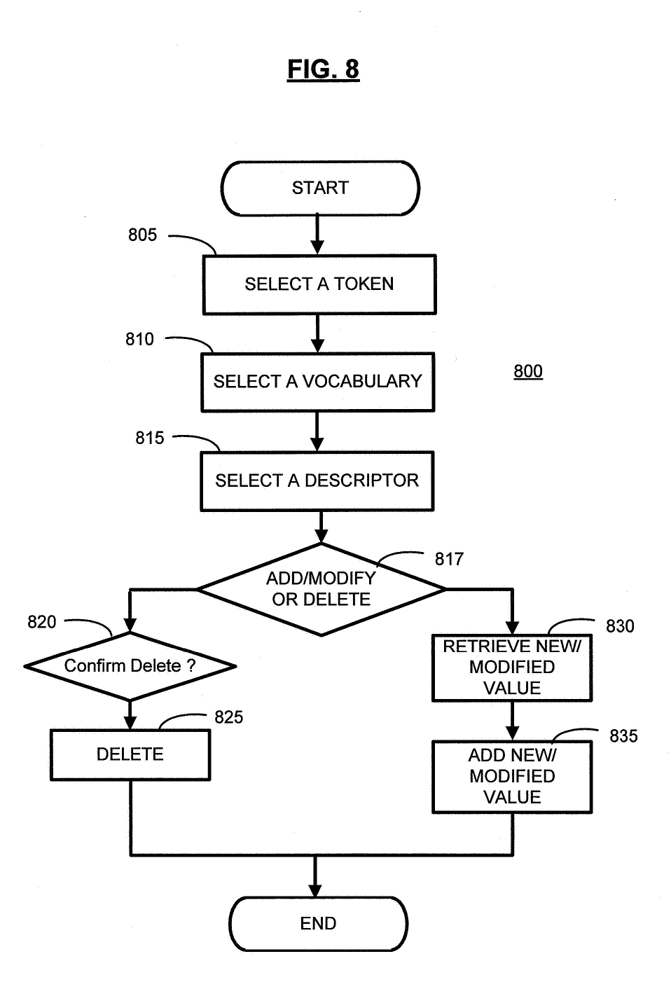

FIG. 8 is a flow chart of a process for adding/modifying/deleting descriptors according to an embodiment of the present invention. The process is implemented by selecting a token, selecting a vocabulary, selecting a descriptor, and providing the new/modified semantic value or asking for it to be removed. Thus, as shown in FIG. 8, the process begins with a selection of an existing token (step 805), a vocabulary (step 810), and a descriptor (step 815). The user then selects an action (e.g., ADD/MODIFY, or DELETE, step 817). If DELETE is selected, the deletion is confirmed (step 820) and the descriptor is deleted (step 825).

If the user selects ADD/MODIFY, a new or modified descriptor is retrieved. Modification may be done, for example, through a GUI. New descriptors can be created or identified to be associated with the selected token/vocabulary. The new descriptor may include, for example, a browse function that allows a user to select form a pool of pre-existing descriptors, or saved descriptors (e.g., descriptors not deleted in a previously executed delete entity action as in, for example, step 750 discussed above). At step 835 the new/modified value is added.

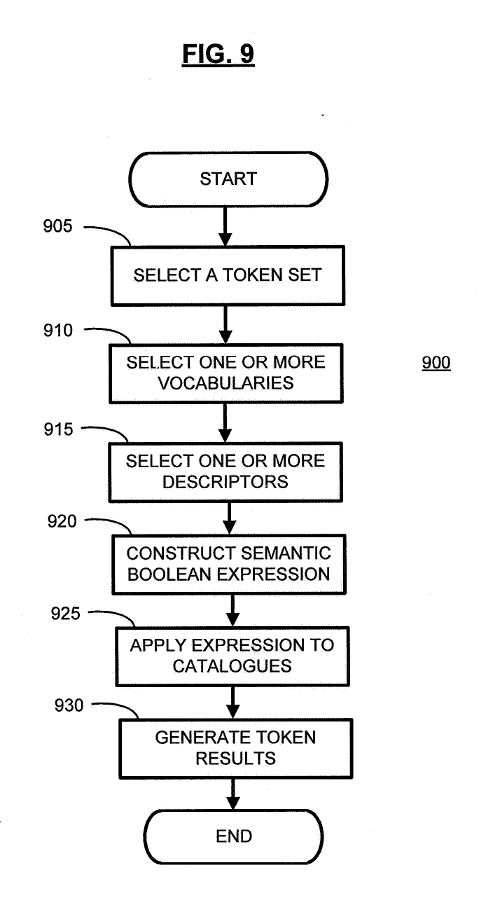

FIG. 9 is a flow chart of a query operation according to an embodiment of the present invention. The query operation includes selecting a token set, selecting one or more vocabularies and one or more descriptors from them, constructing a boolean expression using semantic values, and applying the boolean expression to the catalogs and generate a result set of tokens. The query operation begins, for example, with a token selection (Step 905), selection of one or more vocabularies (e.g., a query user's private vocabularies, another user's public vocabularies, or another user's vocabulary that has been restricted but visible to the query user)(Step 910). A query is constructed (e.g., a boolean expression query in this example) (Step 920), applied to the catalog(s) (Step 925), and corresponding results are generated (930). The matching results are viewed by the user to determine which results most closely match or specifically satisfy the user's intent in making the query.

A catalog according to the present invention may be embodied in different forms. For example, the catalog may refer to a local entity set or to one spread out across many devices.

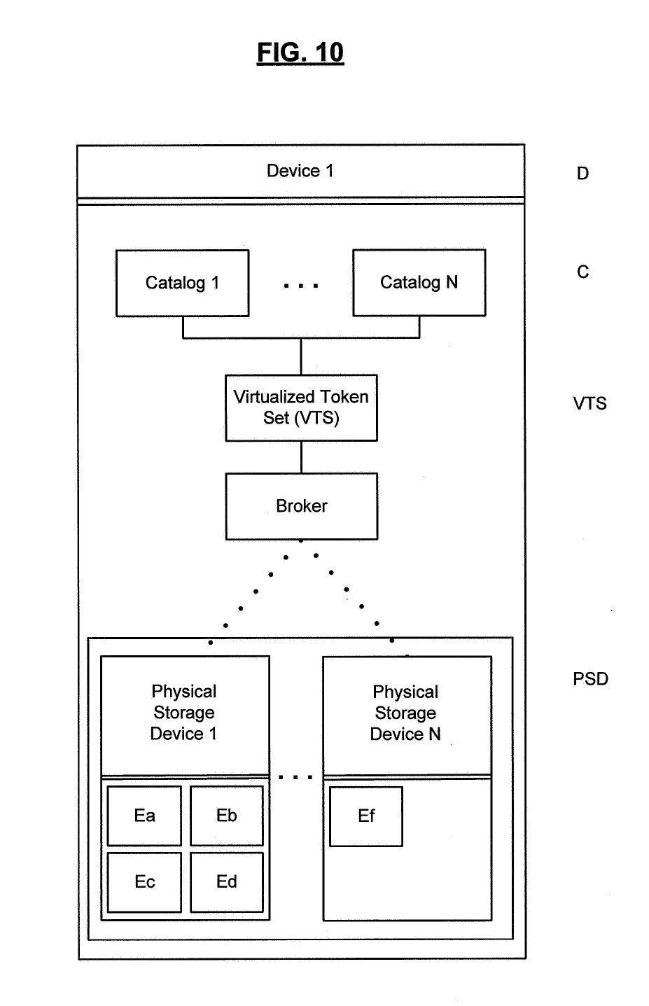

FIG. 10 is an example of a local entity set on a user device according to an embodiment of the present invention. The catalog refers to multiple entities on different Physical Storage Devices (PSDs) in the user device.

FIG. 10 illustrates a single user device that has 1 . . . n catalogs referring to a single virtualized token set which is then resolved via the broker to the actual entities themselves which are stored on the 1 . . . n Physical Storage Devices (PSDs) that make up the device storage. On a computer, for example, the storage devices may be hard drives, optical drives, a USB memory stick, a flash card, etc, and/or any combination of these or other storage devices.

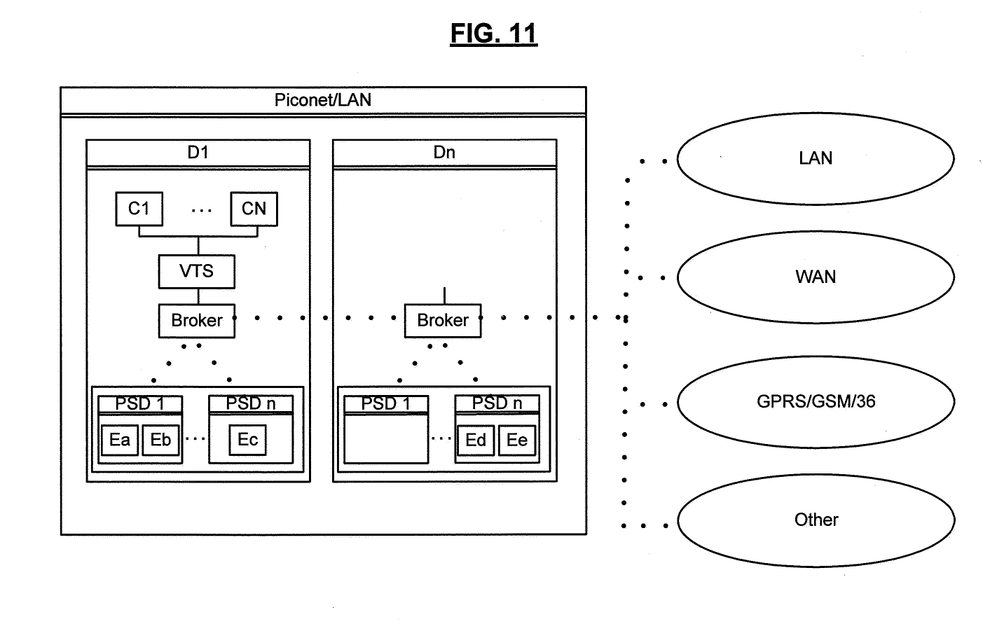

FIG. 11 is an illustration of a distributed entity set according to an embodiment of the present invention. In FIG. 11, a catalog is on one user device, however, the entity set is distributed over multiple user devices. The user devices themselves may be of any type and may include, for example, PDAs, STBs, phones, etc. FIG. 11 shows devices 1 . . . n in a box titled piconet/LAN, which refers to the fact that the devices could be in piconet/PAN (Personal Area Network) which are short range IR/Bluetooth type networks or even peer to peer (device to device), but that they can also hook into other networks. The entities found on other devices or across other networks are coordinated, for example, via a series of brokers that match the entities to corresponding virtualized tokens.

While a catalog itself could be distributed in any number of ways, in practice the invention more efficiently coordinated if it is consolidated on a single device. Further, a catalog(s) and its corresponding Virtualized Token Set(s) may be moved between devices, such as would happen if a user used different accessory devices to get into the virtual domain.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing a peer-to-peer communication or request/response type messaging and file transfer, any other system or other device having an equivalent function or capability, whether or not listed herein, may be substituted therewith. Furthermore, the inventors recognize that newly developed technologies not now known may also be substituted for the described parts and still not depart from the scope of the present invention. All other described items, including, but not limited to servers, networks, file types, descriptors, tokens, sets, etc., should also be considered in light of any and all available equivalents.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CD or DVD RW+/−, micro-drive, and magneto-optical disks, ROMs, RAMs, EPROMs, EEPROMs, DRAMs, VRAMs, flash memory devices (including flash cards, memory sticks), magnetic or optical cards, SIM cards, MEMS, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, identifying entity sets, and the display, storage, or communication of results according to the processes of the present invention.

In one embodiment, the present invention or portions of the present invention operate on a processing device in a portable electronic device, such as a hand held game device, cell phone, or PDA. In one embodiment, steps of the invention or portions of the invention are embodied in processor readable code on a SIM card that may be installed in a card slot in the portable electronic device. The SIM card comprises, for example, a set of computer readable instructions that, when loaded into a processor of a portable device, cause the processor to perform the steps of identifying an entity comprising a resource, assigning a token to the entity, associating at least one meaning to tokens, and placing the token in at least one organizational structure. In one embodiment, the SIM card processor readable instructions further comprise steps for searching the organization structure for a specific asset and/or downloading assets. The downloads may be, for example, performed in a peer-to-peer style arrangement facilitated by a central database of organization structures derived from tokens and descriptors that identify physical assets, including the asset for downloading, located on different devices. The processor readable instructions include a device independent operating system comprising, for example, an AmigaAnywhere™ operating system.

The present invention may suitably comprise, consist of, or consist essentially of, any of element (the various parts or features of the invention) and their equivalents as described herein. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

What is claimed and desired to be secured by letters patent of the United States is:

1. A method, comprising the steps of:
identifying an entity comprising a resource;
assigning a token to the entity;
associating at least one meaning to tokens; and
placing the token in at least one organizational structure.

2. The method according to claim 1, wherein the step of associating, comprises:
building token sets;
building descriptor value sets; and
removing duplicates from the token and descriptor value sets.

3. The method according to claim 1, wherein said step of associating comprises creating an explicit association.

4. The method according to claim 1, wherein said step of pacing the token in at least one organizational structure comprises,
retrieving descriptor properties; and
building at least one vocabulary using the descriptor properties.

5. The method according to claim 4, further comprising the step of building a Catalog from instance of the at least one vocabulary.

6. The method according to claim 1, further comprising the step of searching the organizational structure to identify a token corresponding to a desired asset.

7. The method according to claim 6, wherein the step of search comprises identifying descriptors in a vocabulary that match descriptors of the desired asset.

8. A device, comprising:
means for establishing token representations of assets on a device;
means for cataloging the token representations;
means for associating descriptive identifiers of the tokenized assets with the cataloged token representations; and
vocabulary means for identifying a desired one of the tokenized cataloged assets.

9. The device according to claim 8, wherein said assets comprise computer readable datafiles corresponding to at least one of photographs, music, and videos.

10. The device according to claim 8, wherein said assets comprise computer executable program files corresponding to at least one of games, entertainment packs, and/or players for any of photographs, music, and videos.

11. The device according to claim 8, wherein the means for establishing, means for cataloging, means for associating, and vocabulary means are embodied in a platform independent operating system capable of running on portable devices.

12. The device according to claim 8, further comprising communication means for transmitting vocabulary based searches across a network to a central catalog device for identifying an asset or assets matching the vocabulary based searches on other devices located or accessible via the network.

13. The device according to claim 12, wherein the searches include multiple search terms corresponding to one or more descriptors of the assets being searched for.

14. A SIM card, comprising:
a set of computer readable instructions that, when loaded into a processor of a portable device, cause the processor to perform the steps of:
identifying an entity comprising a resource;
assigning a token to the entity;
associating at least one meaning to tokens; and
placing the token in at least one organizational structure.

15. The SIM card according to claim 14, wherein the computer readable instructions further comprise steps for searching the organization structure for a specific asset.

16. The SIM card according to claim 14, wherein the computer readable instructions further comprise steps for downloading assets identified by the organization structure.

17. The SIM card according to claim 16, wherein said downloading is performed in a peer-to-peer style arrangement facilitated by a central database of organization structures derived from tokens and descriptors that identify physical assets, including the asset for downloading, located on different devices.

18. The SIM card according to claim 14, wherein the different devices and assets located thereon are accessible a wide area network.

19. The SIM card according to claim 14, wherein the computer readable instructions include a device independent operating system.

20. The SIM card according to claim 19, wherein the device independent operating system include an AmigaAnywhere™ operating system.
